(19) United States
(12) Patent Application Publication
(10) Pub. No.: US 2026/0329419 A1
(43) Pub. Date: Oct. 22, 2026

(54) MULTIMEDIA RESOURCE PLAYBACK METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Zirui CHENG, Shenzhen (CN); Shuyuan LI, Shenzhen (CN); Yongwen LIU, Shenzhen (CN); Chuanyu ZHANG, Shenzhen (CN); Peiyao CHENG, Shenzhen (CN); Peng SHI, Shenzhen (CN); Yanhua ZHAO, Shenzhen (CN); You ZHOU, Shenzhen (CN); Dan YANG, Shenzhen (CN); Qiyu WANG, Shenzhen (CN)

(21) Appl. No.: 19/697,114

(22) Filed: Jun. 3, 2026

Related U.S. Application Data
(63) Continuation of application No. PCT/CN2025/084390, filed on Mar. 24, 2025.

(30) Foreign Application Priority Data
May 7, 2024 (CN) 202410559346.9

(51) Int. Cl. G06F 3/0484; G06F 3/0346; G06F 3/04817; G06F 3/0483; G06F 3/16

(52) U.S. Cl. CPC G06F 3/0484; G06F 3/0346; G06F 3/04817; G06F 3/0483; G06F 3/167

(57) ABSTRACT

This application provides a multimedia resource playback method and apparatus, an electronic device, a computer-readable storage medium, and a computer program product, and belongs to the field of computer technologies. The method includes displaying guidance information in response to a playback mode switching condition being satisfied during playback of a first multimedia resource in a first screen playback mode, the guidance information guiding switching from the first screen playback mode to a second screen playback mode; playing the first multimedia resource in the second screen playback mode in response to a switching instruction based on the guidance information; and playing a second multimedia resource in the second screen playback mode in response to a resource switching condition being satisfied, the second multimedia resource being adapted to the second screen playback mode.

### RELATED APPLICATIONS

This application is a continuation of PCT Application No. PCT/CN2025/084390, filed on Mar. 24, 2025, which in turn claims priority to Chinese Patent Application No. 2024105593469, filed on May 7, 2024, both of which are incorporated herein by reference in their entirety.

### FIELD OF THE TECHNOLOGY

This application relates to the field of computer technologies, and in particular, to a multimedia resource playback method and apparatus, an electronic device, a computer-readable storage medium, and a computer program product.

### BACKGROUND OF THE DISCLOSURE

With the development of multimedia technologies, multimedia resources are more widely used. In the related art, a multimedia resource may be played, and a user may switch a screen playback mode according to an actual use requirement. However, in the related art, the display mode of multimedia resources is relatively limited.

### SUMMARY

In view of this, embodiments of this application provide a multimedia resource playback method and apparatus, an electronic device, a computer-readable storage medium, and a computer program product, to enrich multimedia resource display modes. The technical solutions are as follows:

Some embodiments provide a multimedia resource playback method, performed by an electronic device and including displaying guidance information in response to a playback mode switching condition being satisfied during playback of a first multimedia resource in a first screen playback mode, the guidance information guiding switching from the first screen playback mode to a second screen playback mode; playing the first multimedia resource in the second screen playback mode in response to a switching instruction based on the guidance information; and playing a second multimedia resource in the second screen playback mode in response to a resource switching condition being satisfied, the second multimedia resource being adapted to the second screen playback mode.

Embodiments of this application provide an electronic device, including a processor and a memory. The memory is configured to store at least one program, and the at least one program is loaded and executed by the processor to implement the multimedia resource playback method according to some embodiments.

Some embodiments provide a non-transitory computer-readable storage medium, having at least one program stored therein. The at least one program is loaded and executed by a processor to implement the multimedia resource playback method according to some embodiments.

Some embodiments provide the multimedia resource playback method. During playback of the first multimedia resource in the first screen playback mode, the guidance information is displayed in response to the playback mode switching condition being satisfied. The guidance information is configured for guiding switching from the first screen playback mode to the second screen playback mode. As such, diversity of displayed information can be improved. The first multimedia resource is played in the second screen playback mode in response to the switching instruction triggered based on the guidance information. This can improve diversity of interaction during playback of the first multimedia resource. The second multimedia resource is played in the second screen playback mode in response to the resource switching condition being satisfied. The second multimedia resource is adapted to the second screen playback mode.

To be specific, in a case that the first multimedia resource is played, guidance can be provided to switch from the first screen playback mode to the second screen playback mode. The second screen playback mode is adapted to the second multimedia resource. Accordingly, the second multimedia resource can be played in a screen playback mode adapted to the second multimedia resource. This can improve a playback effect of the second multimedia resource. A user can view the second multimedia resource played in the second screen playback mode without performing any operation. The playback mode of the second multimedia resource is adapted to a viewing orientation of the user. This enhances the visual impact and appeal of the multimedia resource, improves viewing experience of the user for the multimedia resource, and can enrich multimedia resource display modes.

### BRIEF DESCRIPTION OF THE DRAWINGS

To describe the technical solutions in some embodiments more clearly, the following briefly describes the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a schematic diagram of an implementation environment according to an embodiment of this application.

FIG. 2 is a flowchart of a multimedia resource playback method according to an embodiment of this application.

FIG. 3 is a flowchart of another multimedia resource playback method according to an embodiment of this application.

FIG. 4 is a schematic diagram of a playback page according to an embodiment of this application.

FIG. 5 is a schematic diagram of another playback page according to an embodiment of this application.

FIG. 6 is a schematic diagram of another playback page according to an embodiment of this application.

FIG. 7 is an interaction flowchart of a multimedia resource playback method according to an embodiment of this application.

FIG. 8 is a flowchart of multimedia resource playback according to an embodiment of this application.

FIG. 9 is a flowchart of another multimedia resource playback according to an embodiment of this application.

FIG. 10 is a block diagram of a multimedia resource playback apparatus according to an embodiment of this application.

FIG. 11 is a block diagram of a terminal according to an embodiment of this application.

FIG. 12 is a block diagram of a server according to an embodiment of this application.

### DESCRIPTION OF EMBODIMENTS

To make the objectives, technical solutions, and advantages of this application clearer, the following describes implementations of this application in detail in some embodiments with reference to the accompanying drawings.

The terms “first”, “second”, and the like used in this application are used for distinguishing identical or similar items that have essentially the same effects and functions. There is no logical or temporal dependency relationship between “first”, “second”, and “nth”, and there is no limitation on quantities and execution orders.

In this application, the term “at least one” means one or more, and “a plurality of” means two or more.

Information (including but not limited to user equipment information, user personal information, and the like), data (including but not limited to data for analysis, stored data, displayed data, and the like), and signals involved in this application are all authorized by users or fully authorized by all parties, and collection, use, and processing of relevant data need to comply with relevant laws, regulations, and standards of relevant countries and regions. For example, second multimedia resources involved in this application are all obtained with full authorization.

The following describes an implementation environment related to this application.

A multimedia resource playback method according to embodiments of this application can be performed by an electronic device. The electronic device may be provided as a server or a terminal. The following describes a schematic diagram of an implementation environment of the multimedia resource playback method according to some embodiments.

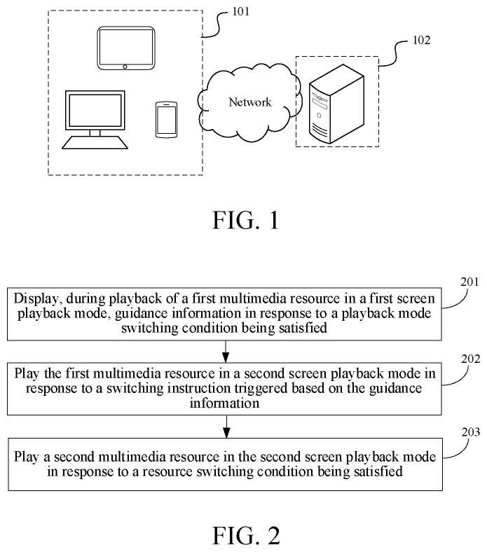

FIG. 1 is a schematic diagram of an implementation environment according to an embodiment of this application, namely, a schematic diagram of an implementation environment of a multimedia resource playback method according to an embodiment of this application. The implementation environment includes a terminal 101 and a server 102. The terminal 101 and the server 102 may be directly or indirectly connected to each other by using a wired or wireless communication protocol. This is not limited in this application. In some embodiments, an application program is equipped on the terminal 101. The terminal 101 plays a first multimedia resource at an exposure position of the application program. To be specific, a display page of the application program may be displayed on a display interface of the terminal 101, and the first multimedia resource is displayed on the display page of the application program. The first multimedia resource is configured for advertising an object. An object is this application may refer to an item advertised by the multimedia resources, or a data item or content item indicated by the multimedia resources.

The terminal 101 jumps to a detail page of the object in response to a trigger operation for the first multimedia resource. The terminal 101 plays a second multimedia resource in response to playback of the first multimedia resource being completed. In some embodiments, the terminal 101 may play the first multimedia resource in a first screen playback mode.

The second multimedia resource may be a multimedia resource that has been played but has not yet been fully played in the application program. Alternatively, the second multimedia resource may be a multimedia resource that is not played in the application program. In some embodiments, a description is made by using an example in which the second multimedia resource is a multimedia resource that has been played but has not yet been fully played in the application program. The second multimedia resource may be an image, a video, text, or the like. In some embodiments, a description is made by using an example in which the second multimedia resource is a video.

In some embodiments, the terminal 101 plays the first multimedia resource in the first screen playback mode in response to playback duration of the second multimedia resource reaching third duration. In some embodiments, the second multimedia resource is a multimedia resource played when the application program is last closed. The terminal 101 plays the first multimedia resource in the first screen playback mode in response to the page of the application program being displayed and the second multimedia resource being played when display of the page is last canceled.

In some embodiments, the second multimedia resource may be displayed on the page of the application program. The terminal 101 plays the first multimedia resource in the first screen playback mode in response to a playback instruction for the second multimedia resource.

In some embodiments, during playback of the first multimedia resource in the first screen playback mode, the terminal 101 displays guidance information in response to a playback mode switching condition being satisfied. The guidance information is configured for guiding switching from the first screen playback mode to a second screen playback mode.

The terminal 101 plays the first multimedia resource in the second screen playback mode in response to a switching instruction triggered based on the guidance information, and plays a second multimedia resource in the second screen playback mode in response to a resource switching condition being satisfied. The second multimedia resource is adapted to the second screen playback mode.

That is, the terminal 101 may first play the first multimedia resource in the first screen playback mode, continue to play the first multimedia resource in the second screen playback mode, and play the second multimedia resource in the second screen playback mode in response to the resource switching condition being satisfied.

In some embodiments, the terminal 101 further displays information about the second multimedia resource during playback of the first multimedia resource. The information about the second multimedia resource includes at least one of a name, a cover image, a played image, and the like of the second multimedia resource.

In some embodiments, before playing the first multimedia resource, the terminal 101 may transmit a resource request to the server 102. The resource request may be configured for requesting the first multimedia resource and a second multimedia resource, and the second multimedia resource further includes the information about the second multimedia resource. Then, the server 102 may return the first multimedia resource and the second multimedia resource to the terminal 101. The terminal 101 may play the first multimedia resource, and display the information about the second multimedia resource during playback of the first multimedia resource.

In some embodiments, the terminal 101 may be, but is not limited to, a smartphone, a tablet computer, a notebook computer, a desktop computer, an intelligent voice interaction device, an intelligent appliance, an in-vehicle terminal, an aircraft, a virtual reality (VR) apparatus, an augmented reality (AR) apparatus, or the like. In some embodiments, the server 102 may be an independent server, or a server cluster or distributed system including a plurality of servers, or a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence (AI) platform. In some embodiments, the server 102 undertakes the primary computing work and the terminal 101 undertakes the secondary computing work. Alternatively, the server 102 undertakes the secondary computing work and the terminal 101 undertakes the primary computing work. Alternatively, the server 102 and the terminal 101 adopt a distributed computing architecture for collaborative computing.

FIG. 2 is a flowchart of a multimedia resource playback method according to an embodiment of this application. The following describes, with reference to operations shown in FIG. 2 and by using an example in which an electronic device is a terminal, the multimedia resource playback method according to some embodiments.

201: Display, during playback of a first multimedia resource in a first screen playback mode, guidance information in response to a playback mode switching condition being satisfied.

In some embodiments, the first multimedia resource may be configured for advertising an object. The object may be an application, an item, a video, or the like. This is not specifically limited herein. The first multimedia resource may be at least one of an image, a video, text, and the like. In some embodiments, during playback of the first multimedia resource in the first screen playback mode, a jump to a detail page of the object may be performed in response to a trigger operation for the first multimedia resource, that is, the display is switched from the first multimedia resource to the detail page of the object.

The detail page of the object may include one or more of information about the object, a function that can be implemented by the object, a characteristic of the object, and an evaluation provided by a user who uses the object in relation to the object. The first multimedia resource is configured for attracting attention of the user to the object, and the detail page is configured for presenting detailed information about the object.

During practical application, an application program may be equipped on the terminal. The application program may be one or more of a video application program, a social application program, and an online education application program. A page of the application program may be displayed in response to a trigger operation for the application program.

In some embodiments, the first multimedia resource may be played in the first screen playback mode on the page of the application program, that is, the first multimedia resource is displayed in a first display mode. The display mode is configured for representing a display orientation of the first multimedia resource on the page. The display mode may include a horizontal display mode (corresponding to a landscape mode), a vertical display mode (corresponding to a portrait mode), an inverted display mode (corresponding to the landscape mode), and the like.

The following describes playback of the first multimedia resource. Playing the first multimedia resource means displaying the first multimedia resource. In a case where the first multimedia resource is a video, playing the first multimedia resource may refer to playing the video, or may refer to pausing the video, or may refer to loading the video. In a case that the first multimedia resource is at least one of an image or text, the at least one of the image and the text may be changeable, or may be unchangeable. In a case where the first multimedia resource is audio, a preset audio icon may be displayed, and the audio is played or not played at the same time.

In some embodiments, in response to first playback duration reaching first duration, it is determined that the playback mode switching condition is satisfied, and the guidance information is displayed in response to the playback mode switching condition being satisfied. The first playback duration is duration of playing the first multimedia resource in the first screen playback mode, and the guidance information is configured for guiding switching from the first screen playback mode to a second screen playback mode. The guidance information may be displayed in the form of a floating layer or a pop-up window.

In some embodiments, in response to second playback duration reaching second duration, it is determined that the playback mode switching condition being satisfied, and the guidance information is displayed in response to the playback mode switching condition being satisfied. The second playback duration is configured for playing a second multimedia resource in a case that the second playback duration is equal to 0. The second playback duration is equivalent to duration corresponding to a countdown, and the second duration is greater than 0.

In some embodiments, in response to the first playback duration reaching the first duration and the second playback duration reaching the second duration, it is determined that the playback mode switching condition is satisfied, and the guidance information is displayed in response to the playback mode switching condition being satisfied. When the first playback duration reaches the first duration, the second playback duration may reach the second duration, or the second playback duration may not reach the second duration. In operation 201, the guidance information can be displayed. This can improve diversity of displayed information.

In some embodiments, the first duration may be set and modified as required. In some embodiments, the first duration may be equal to zero. That is, the terminal displays guidance information while playing the first multimedia resource in the first screen playback mode. This guidance information is the guidance information.

In some embodiments, the first duration may be greater than 0. That is, the terminal may first play the first multimedia resource in the first screen playback mode, and display the guidance information when the first playback duration reaches the first duration.

In some embodiments, the first screen playback mode is a landscape mode or a portrait mode. In a case where the first screen playback mode is the landscape mode, the guidance information is configured for guiding rotating a screen from a landscape orientation to a portrait orientation. In a case where the first screen playback mode is the portrait mode, the guidance information is configured for guiding rotating the screen from the portrait orientation to the landscape orientation.

202: Play the first multimedia resource in a second screen playback mode in response to a switching instruction triggered based on the guidance information.

In some embodiments, the guidance information may include at least one of text, an image, and a video. For example, the text may be “Please rotate a display orientation of a page”. For another example, the image may be an image representing a rotating page. For another example, the video may be a video representing a rotating page. Based on the guidance information, the user may trigger the switching instruction by rotating the terminal. The first multimedia resource is played in the second screen playback mode in response to the switching instruction triggered based on the guidance information. As such, the user may be guided to switch the screen playback mode. This can improve diversity of interaction during playback of the first multimedia resource, and can improve a correlation between the displayed guidance information and the interaction instruction executed for the guidance information.

In some embodiments, in a case where the guidance information is displayed, a switch control may be correspondingly displayed. The guidance information may be configured for guiding switching from the first screen playback mode to the second screen playback mode based on the switch control. Based on the guidance information, the switching instruction is obtained in response to a trigger operation for the switch control. The first multimedia resource is played in the second screen playback mode in response to the switching instruction triggered based on the guidance information. As such, one-click switching of the screen playback mode can be achieved. This can improve diversity of interaction during playback of the first multimedia resource.

In some embodiments, the terminal may automatically adjust the screen playback mode while displaying the guidance information, that is, automatically switch the first screen playback mode to the second screen playback mode. In this case, the guidance information is equivalent to prompt information. The guidance information is configured for prompting switching from the first screen playback mode to the second screen playback mode. The switching instruction may be transmitted by the server to the terminal, or may be triggered by executing code. As such, automatic switching of the screen playback mode can be achieved. This improves user experience.

In some embodiments, the first screen playback mode is automatically switched to the second screen playback mode in response to duration of displaying the guidance information reaching seventh duration. The switching instruction may be transmitted by the server to the terminal, or may be triggered by executing code. As such, automatic switching of the screen playback mode can be achieved. This improves user experience.

In some embodiments, after displaying the first multimedia resource for eighth duration, the terminal automatically adjusts the screen playback mode, that is, automatically switches the first screen playback mode to the second screen playback mode. The eighth duration is greater than the first duration. That is, when the guidance information is displayed for particular duration (which may be the seventh duration, or may be another duration), the screen playback mode may be automatically adjusted. As such, automatic switching of the screen playback mode can be achieved. This improves user experience.

After the first screen playback mode is automatically switched to the second screen playback mode, the first multimedia resource may be played in the second screen playback mode. That is, in some embodiments, the first multimedia resource may be played in the second screen playback mode in response to the switching instruction triggered based on the guidance information.

In some embodiments, the first multimedia resource includes a first sub-resource adapted to the first screen playback mode and a second sub-resource adapted to the second screen playback mode. The first sub-resource adapted to the first screen playback mode may be played in the first screen playback mode, and the second sub-resource adapted to the second screen playback mode may be played in the second screen playback mode. Correspondingly, the eighth duration is duration of playing the first sub-resource adapted to the first screen playback mode. If the first screen playback mode is the portrait mode, the second screen playback mode is the landscape mode. If the first screen playback mode is the landscape mode, the second screen playback mode is the portrait mode.

203: Play a second multimedia resource in the second screen playback mode in response to a resource switching condition being satisfied.

In some embodiments, in response to third playback duration reaching fourth duration, it is determined that the resource switching condition is satisfied, and the second multimedia resource is played in the second screen playback mode in response to the resource switching condition being satisfied. The third playback duration is duration of displaying the first multimedia resource in the second screen playback mode, and the second multimedia resource is adapted to the second screen playback mode.

In the multimedia resource playback method according to some embodiments, in a case that the multimedia resource is an image or a video, an adaptive screen playback mode may be determined according to an aspect ratio of the multimedia resource. For example, an aspect ratio of a landscape video is 16:9. If the multimedia resource is a landscape video, the multimedia resource is adapted to the landscape mode (the second screen playback mode). An aspect ratio of a portrait video is 9:16. If the multimedia resource is a portrait video, the multimedia resource is adapted to the portrait mode (the second screen playback mode).

When the multimedia resource is text, the text may be displayed in an electronic document, and an adaptive screen playback mode may be determined according to a font size of the text in the electronic document. A display effect of a multimedia resource can be improved by playing the multimedia resource in a screen playback mode adapted to the multimedia resource.

In some embodiments, in response to playback of the first multimedia resource being completed, it is determined that the resource switching condition is satisfied, and the second multimedia resource is played in the second screen playback mode in response to the resource switching condition being satisfied.

In some embodiments, in response to the third playback duration reaching the fourth duration and playback of the first multimedia resource being completed, it is determined that the resource switching condition is satisfied, and the second multimedia resource is played in the second screen playback mode in response to the resource switching condition being satisfied.

Some embodiments provide the multimedia resource playback method. During playback of the first multimedia resource in the first screen playback mode, the guidance information is displayed in response to the playback mode switching condition being satisfied. The guidance information is configured for guiding switching from the first screen playback mode to the second screen playback mode. As such, diversity of displayed information can be improved. The first multimedia resource is played in the second screen playback mode in response to the switching instruction triggered based on the guidance information. This can improve diversity of interaction during playback of the first multimedia resource. The second multimedia resource is played in the second screen playback mode in response to the resource switching condition being satisfied. The second multimedia resource is adapted to the second screen playback mode.

That is, in a case that the first multimedia resource is played, guidance can be provided to switch from the first screen playback mode to the second screen playback mode. The second screen playback mode is adapted to the second multimedia resource. Accordingly, the second multimedia resource can be played in a screen playback mode adapted to the second multimedia resource. This can improve a playback effect of the second multimedia resource. A user can view the second multimedia resource played in the second screen playback mode without performing any operation. Accordingly, the playback mode of the second multimedia resource is adapted to a viewing orientation of the user. This enhances a visual impact and appeal of the multimedia resource, improves viewing experience of the user on the multimedia resource, and can enrich multimedia resource display modes.

In the multimedia resource playback method according to some embodiments, the first screen playback mode of the multimedia resource may be switched to the second screen playback mode. This improves diversity of presentation of the multimedia resource. Furthermore, the guidance information is displayed to guide the user to rotate the screen. This improves diversity of interaction modes. In addition, in the method, after the user is guided to rotate the screen, and after playback of the first multimedia resource in the second screen playback mode is completed, the second multimedia resource is then directly played in the second screen playback mode. Accordingly, because the user is guided to rotate the screen before the second multimedia resource is played, the user may directly view the second multimedia resource played in the second screen playback mode without performing any operation. This allows presentation of the multimedia resource to be closely aligned with a viewing orientation of the user, enhances a visual impact and appeal of the multimedia resource, and further improves viewing experience of the user. In addition, playing the multimedia resource in such a novel and attractive presentation form can attract attention of the user, increase a conversion rate of the first multimedia resource, and further improve a promotion effect of the object promoted by the first multimedia resource.

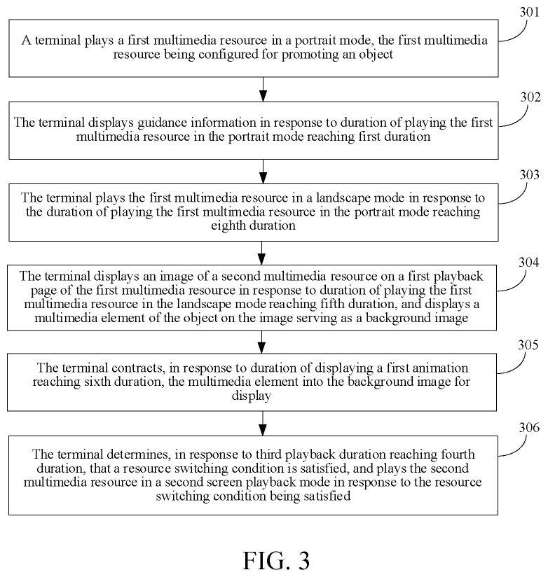

FIG. 2 is a basic procedure of the multimedia resource playback method. The following further describes the multimedia resource playback method with reference to FIG. 3. FIG. 3 is a flowchart of another multimedia resource playback method according to an embodiment of this application. In this embodiment, a description is made by using an example in which the first screen playback mode is the portrait mode and the second screen playback mode is the landscape mode. For a case that the first screen playback mode is the landscape mode and the second screen playback mode is the portrait mode, equivalent replacement may be made to the following content, and details are not described herein again.

301: A terminal plays a first multimedia resource in a portrait mode, the first multimedia resource being configured for promoting an object.

In some embodiments, the terminal plays the first multimedia resource on a page of an application program. A first playback page of the first multimedia resource is the page of the application program. The playback page includes, but is not limited to, a startup page of the application program, a page on which the application program displays another multimedia resource, and a page on which the application program plays another multimedia resource.

In some embodiments, if the playback page is the startup page of the application program, the startup page of the application program may be displayed in response to a startup instruction for the application program, and the first multimedia resource is played in the portrait mode on the startup page of the application program.

In some embodiments, the playback page is the page on which the application program displays another multimedia resource. The first play resource may be played in the portrait mode while floating above another multimedia resource, or may be played in the portrait mode in a first area of the page.

In some embodiments, the playback page is the page on which the application program plays another multimedia resource. The first multimedia resource may be played in the portrait mode while covering another multimedia resource, or the first multimedia resource may be played in the portrait mode in a second area of the page.

In some embodiments, the terminal jumps to a detail page of the object in response to a trigger operation for the first multimedia resource. In some embodiments, a close control for the first multimedia resource is further displayed on the first playback page of the first multimedia resource. The terminal cancels playback of the first multimedia resource in response to a trigger operation for the close control, that is, cancels display of the first multimedia resource.

In some embodiments, after completing playback of the first multimedia resource, the terminal plays a second multimedia resource. The second multimedia resource may be a multimedia resource that has been played but has not yet been fully played in the application program. The second multimedia resource may be a short video, a television series, a movie, a novel, or the like. Alternatively, the second multimedia resource may be a multimedia resource that is not played.

In some embodiments, the process in which the terminal plays the first multimedia resource in the portrait mode includes at least one of the following implementations. First implementation: After playing the second multimedia resource for third duration, the terminal plays the first multimedia resource in the portrait mode. That is, the first multimedia resource is played in the first screen playback mode in response to duration of playing the second multimedia resource reaching the third duration.

In the first implementation, after the second multimedia resource is played for the third duration, the first multimedia resource is played in the portrait mode, to achieve interleaved playback of the first multimedia resource during playback of the second multimedia resource, and further achieve promotion of the object in the first multimedia resource during playback of the second multimedia resource. This can attract attention of a user to the object, and improve visibility and an exposure rate of the first multimedia resource.

The second multimedia resource may be any multimedia resource in the application program. The third duration may be set and modified as required. The second multimedia resource may be played in a landscape mode or the portrait mode. This is not specifically limited herein.

Second implementation: The terminal plays the first multimedia resource in the portrait mode in a case that the application program is started and the second multimedia resource exists in the application program, and the second multimedia resource is a multimedia resource played when the application program is last closed. The starting the application program includes starting the application program for the first time, and switching from the page of the application program to another page and then switching back to the page of the application program. The second multimedia resource is a multimedia resource displayed in the application program.

That is, the first multimedia resource is played in the first screen playback mode in response to the page of the application program being displayed and the second multimedia resource being played when display of the page is last canceled. The second multimedia resource is a multimedia resource played when the application program is last closed. That is, the second multimedia resource is a multimedia resource that has been played but has not yet been fully played in the application program.

In the second implementation, in a case that the second multimedia resource that is not fully played last time exists in the application program, and in a case that the page of the application program is display again, the first multimedia resource may be played in the portrait mode, to achieve promotion of the object in the first multimedia resource. This can attract attention of the user to the object, and improve visibility and the exposure rate of the first multimedia resource. Furthermore, playback of the previously played second multimedia resource is automatically resumed after playback of the first multimedia resource is completed without the need for the user to trigger the second multimedia resource. This improves interaction efficiency.

Third implementation: The terminal may play the first multimedia resource in the portrait mode in response to a playback instruction for the second multimedia resource in the application program. A plurality of multimedia resources may be displayed on the page of the application program. In response to a selection operation for any multimedia resource, a multimedia resource corresponding to the selection operation is used as the second multimedia resource. The playback instruction for the second multimedia resource is triggered, and the first multimedia resource may be played in the first screen playback mode.

The second multimedia resource is a multimedia resource that is not played. In the third implementation, the first multimedia resource may be played in the portrait mode when the non-played multimedia resource is triggered. That is, the first multimedia resource is played before the non-played multimedia resource is played, to achieve promotion of the object in the first multimedia resource. This can attract attention of the user to the object, and improve visibility and the exposure rate of the first multimedia resource.

In some embodiments, an example in which the first screen playback mode is the portrait mode is used, and playback of the first multimedia resource in the first screen playback mode is achieved through the foregoing three implementations. This can achieve promotion of the object in the first multimedia resource, attract attention of the user to the object, and improve visibility and the exposure rate of the first multimedia resource.

In some embodiments, before the terminal displays the first multimedia resource, a multimedia resource engine creates the multimedia resource based on content. During creation of the multimedia resource, an organization to which the multimedia resource belongs selects an object, and then delivers a multimedia resource of the object for screen rotation (that is, the object switches a screen playback mode).

In some embodiments, content, such as a customized material for switching from the portrait mode to the landscape mode, a text, and a frame-breaking animation of the multimedia element, may be uploaded to a delivery terminal of the multimedia resource. The frame-breaking animation refers to an animation that visually breaks through boundaries displayed on the page, to deliver a visual impact to the user.

The delivery terminal transmits the content to the multimedia resource engine, and the multimedia resource engine generates the multimedia resource (the first multimedia resource) for screen rotation and binds the uploaded content. Before playing the first multimedia resource, the terminal transmits a resource request to a server. The resource request is configured for requesting a multimedia resource. The server obtains the first multimedia resource from the multimedia resource engine, and delivers the first multimedia resource to the terminal, and the terminal displays the first multimedia resource.

In some embodiments, the server may obtain resource data from the multimedia resource engine. The resource data includes page rendering data of information about the to-be-played first multimedia resource, a multimedia element, a second multimedia resource, and the like. The resource data further includes information for determining a switching condition and whether a resource switching condition is satisfied.

In some embodiments, the application program accesses the second multimedia resource with authorization of the user. Authorization prompt information, an agree-control, and a disagree-control are displayed on the terminal used by the user. The authorization prompt information is configured for prompting authorization to access the second multimedia resource. The agree control is configured to indicate that the user agrees to the application program accessing the second multimedia resource. In response to a trigger operation for the agree control, which is equivalent to in response to an agree instruction for the authorization prompt information, the application program may access the second multimedia resource stored in the terminal.

The disagree-control is configured to indicate that the user disagrees with the application program accessing the second multimedia resource. In response to a trigger operation for the disagree-control, that is, in response to a disagree instruction for the authorization prompt information, the application program cannot access the second multimedia resource stored in the terminal. As such, security of the second multimedia resource may be protected. In some embodiments, in operation 301, the process of playing the first multimedia resource in the first screen playback mode is implemented.

302: The terminal displays guidance information in response to duration of playing the first multimedia resource in the portrait mode reaching first duration.

In some embodiments, switching from the portrait mode to the landscape mode is used as an example, and the guidance information is further configured for guiding rotating the screen from a portrait orientation to a landscape orientation. Switching from the landscape mode to the portrait mode is used as an example, and the guidance information is further configured for guiding rotating the screen from the landscape orientation to the portrait orientation. In some embodiments, the guidance information may be configured for guiding switching from a first display orientation to a second display orientation.

In some embodiments, the foregoing process in which the terminal displays the guidance information includes the following implementation: The terminal displays the guidance information in the form of a text or in the form of an icon. In some embodiments, displaying the guidance information in the form of a text may enable the user to readily understand the guidance information based on the copy. This facilitates triggering a switching instruction. Displaying the guidance information in the form of an icon can increase fun of the display. This facilitates attracting attention of the user to the guidance information, and further promote triggering of a switching instruction.

In some embodiments, the copy is further configured for prompting clicking to jump to the detail page of the object. Alternatively, a jump to the detail page of the object may be performed in a manner other than clicking. Correspondingly, jumping from the first playback page of the first media information to the detail page of the object in response to the trigger operation for the guidance information is equivalent to displaying the detail page of the object.

The detail page of the object may be a page corresponding to the application program, or may be a page outside the application program. If the detail page of the object is the page corresponding to the application program, a jump to the page may be directly performed in the application program. If the detail page of the object is the page outside the application program, a jump to the detail page of the object in a third-party application may be performed.

In some embodiments, the terminal displays the guidance information in both the form of a text and the form of an icon. Displaying the guidance information in a plurality of manners can further attract attention of the user and help the user understand the guidance information. This further promotes the user to perform a screen rotation operation, that is, further promotes triggering a switching instruction.

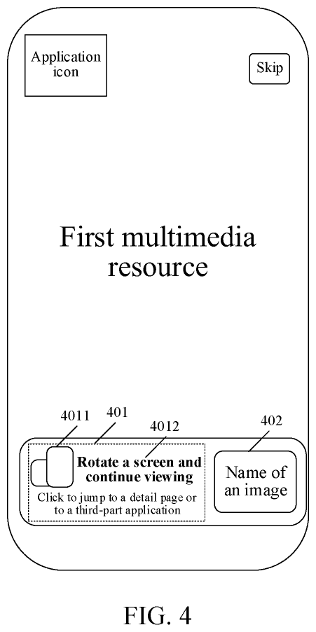

A display position of the guidance information on the first playback page of the first multimedia resource may be set and modified as required. For example, the guidance information is displayed at the bottom of the playback page, to reduce obstruction of the first multimedia resource. For example, FIG. 4 is a schematic diagram of a playback page according to an embodiment of this application. On the playback page, a first multimedia resource is played and guidance information 401 is displayed. The guidance information 401 includes an icon 4011 and a text 4012.

In some embodiments, the process in which the terminal plays the guidance information in the form of an icon includes the following implementations: The icon may be a displayed dynamic icon. The dynamic icon is configured to demonstrate a process of rotating a screen of an electronic device. In some embodiments, an example in which the screen is rotated from the portrait orientation to the landscape orientation is used, and the dynamic icon is configured to demonstrate a process of rotating the terminal from the portrait orientation to the landscape orientation. The dynamic icon can demonstrate a screen rotation process. This improves attractiveness, is more convenient for the user to understand, promotes the user to rotate the screen (trigger the switching instruction) based on the demonstrated screen rotation process, and further improves a guiding effect of the guidance information.

In some embodiments, the dynamic icon includes a first icon and a second icon. The first icon is displayed in the portrait mode, and the second icon is displayed in the landscape mode (which is merely an example, and the first icon and the second icon may be interchanged), and the dynamic icon displays a process of rotating the first icon to coincide with the second icon. Alternatively, the dynamic icon includes only the first icon, and the dynamic icon displays a process of rotating the first icon from the portrait orientation to the landscape orientation.

In some embodiments, second prompt information (namely, resource prompt information) of the second multimedia resource is displayed in response to the playback mode switching condition being satisfied. The resource prompt information is configured for prompting the to-be-played second multimedia resource. As such, diversity of displayed information can be improved.

The second prompt information of the second multimedia resource includes at least one of a name, an image, and a brief introduction of the second multimedia resource. The image of the second multimedia resource may be a cover image of the second multimedia resource, or may be a played image of the second multimedia resource, or may be any image of the second multimedia resource. This is not specifically limited herein.

In some embodiments, the second prompt information and the guidance information may be displayed on a same component, to further reduce obstruction of the first multimedia resource. Refer to FIG. 4 again. Second prompt information 402 of the second multimedia resource is further displayed on the playback page. The second prompt information 402 includes a name and an image of the second multimedia resource.

In this embodiment, the second multimedia resource may be played after playback of the first multimedia resource is completed. During playback of the first multimedia resource, first prompt information is configured for transparently transmitting content that the second multimedia resource is played next in advance. The transparently communicated content can attract attention of the user, increase a viewing rate of the first multimedia resource by the user, reduce user attrition, and also improve transition of playback of different multimedia resources, and improve user experience.

In some embodiments, the terminal jumps to a second playback page of the second multimedia resource in response to a trigger operation for the first prompt information, and plays the second multimedia resource. In this embodiment, when the user triggers the resource prompt information, it indicates that the user is interested in the prompted second multimedia resource, and then the terminal directly jumps to play the second multimedia resource. This improves diversity of interaction and user experience.

In some embodiments, the terminal jumps to a main page of the second multimedia resource in response to a trigger operation for the second prompt information. The main page includes information such as an image and a text introduction of the second multimedia resource. It is convenient for the user to intuitively learn the information about the second multimedia resource.

303: The terminal plays the first multimedia resource in a landscape mode in response to the duration of playing the first multimedia resource in the portrait mode reaching eighth duration.

In some embodiments, the eighth duration is greater than the first duration. That is, after the guidance information is displayed for a period of time, the first screen playback mode is automatically switched to a second screen playback mode, to achieve screen rotation. Accordingly, sufficient reaction time is given to the user, and the user can perform a screen rotation operation. This improves consistency between displayed content and a user interaction, and improves user experience.

In some embodiments, the first duration is equal to the eighth duration. That is, the terminal plays the first multimedia resource in the landscape mode while displaying the guidance information. In some embodiments, display of the guidance information is canceled after the guidance information is displayed for ninth duration. The ninth duration is not greater than a duration difference between the eighth duration and the first duration. Alternatively, display of the guidance information is canceled in a process of rotating the electronic device to the landscape orientation.

In some embodiments, after the terminal plays the first multimedia resource in the landscape mode, whether the terminal is rotated to the landscape orientation may be detected. In a case that the terminal is not rotated to the landscape orientation, the guidance information is displayed in a highlighted manner, to further guide the user to rotate the screen. This improves diversity of interaction. That the guidance information is displayed in the highlighted manner may be shaking the guidance information, enlarging the guidance information, changing a display color of the guidance information, or the like. In operation 303, the process of automatically playing the first multimedia resource in the second screen playback mode after the first multimedia resource is played in the first screen playback mode for the eighth duration is implemented.

304: The terminal displays an image of a second multimedia resource on a first playback page of the first multimedia resource in response to duration of displaying the first multimedia resource in the landscape mode reaching fifth duration, and displays a multimedia element of the object on the image serving as a background image.

The fifth duration may be set and modified as required. This is not specifically limited herein. In some embodiments, the fifth duration is equal to zero. That is, after being rotated to the landscape orientation, the terminal immediately displays the image of the second multimedia resource on the playback page, and no longer plays the first multimedia resource in the landscape mode.

The image of the second multimedia resource includes at least one of a first image and a second image. The first image is a played image of the second multimedia resource. The second image is a cover image of the second multimedia resource.

In some embodiments, the terminal may sequentially display the image of the second multimedia resource and the multimedia element of the object. For example, after playing the first multimedia resource in the landscape mode for the fifth duration, the terminal displays the image of the second multimedia resource on the first playback page of the first multimedia resource, and displays, in response to duration of displaying the image reaching tenth duration, the multimedia element of the object on the image serving as the background image. Alternatively, after playing the first multimedia resource in the landscape mode for the fifth duration, the terminal displays the multimedia element of the object on the playback page serving as the background, and after playing the multimedia element for eleventh duration, the terminal displays the image of the second multimedia resource on the playback page, and displays the multimedia element of the object on the image serving as the background image.

In some embodiments, after playback of the first multimedia resource is completed, the second multimedia resource may be played. During playback of the first multimedia resource of the object, information about the second multimedia resource may be synchronously displayed, to achieve a correlation between the first multimedia resource and to-be-played content, that is, to achieve a smooth transition between the first multimedia resource and the to-be-played content. This enables the user to readily remember content of the first multimedia resource, and improves a display effect of the first multimedia resource. Displaying the multimedia element of the object can further highlight the object, and further improve a promotion effect of the object. The image of the to-be-played content is displayed, and the multimedia element of the object is displayed on the image serving as the background image. Accordingly, a transparent transition to the to-be-played content is achieved while highlighting the object, to enhance a sense of transition between the first multimedia resource and the to-be-played content (the second multimedia resource), and further improve viewing experience of the user. This enables the user to readily remember the content of the first multimedia resource, and further improves a display effect of the first multimedia resource. In addition, the transparently transmitted to-be-played content can further attract attention of the user and encourage the user to continue viewing the displayed content. This improves a viewing rate of the displayed content by the user and reduces user attrition.

In some embodiments, in a case that the first multimedia resource is configured for recommending the object, the multimedia element of the recommended object is displayed in response to third playback duration reaching the fifth duration. The third playback duration refers to duration of displaying the first multimedia resource in the second screen playback mode. The multimedia element may be configured for enriching propagation effects of the object. The multimedia element may be one or more of an icon of the object, a video of the object, and a name of the object.

In some embodiments, the image of the second multimedia resource is displayed on the first playback page of the first multimedia resource in response to the third playback duration reaching the fifth duration. The fifth duration is less than fourth duration. As such, the user may learn the image of the second multimedia resource in advance. This can improve diversity of displayed information.

In some embodiments, the foregoing process in which the terminal displays the multimedia element of the object includes the following operations: The terminal displays a first animation of the multimedia element, the first animation being a frame-breaking animation, and the multimedia element being displayed in a manner of being moved out of the first playback page in the first animation.

The multimedia element is configured for presenting an appearance and form of the object. The multimedia element in the frame-breaking animation is presented in a dynamic manner. In some embodiments, the multimedia element has a plurality of forms, and in the frame-breaking animation, a transformation process of the plurality of forms of the multimedia element is displayed. For example, if the object is a foldable item, in the frame-breaking animation, transformation of the object from a folded state to an unfolded state may be displayed.

In some embodiments, the first multimedia resource includes the multimedia element of the object. In the frame-breaking animation, a process of moving the multimedia element out of the playback page and then dynamically displaying the multimedia element on a floating layer of the playback page is displayed, to further improve transition of page display, and further improve a playback effect of the multimedia resource. In some other embodiments, in the frame-breaking animation, a process of dynamically displaying the multimedia element directly on the floating layer of the playback page is displayed.

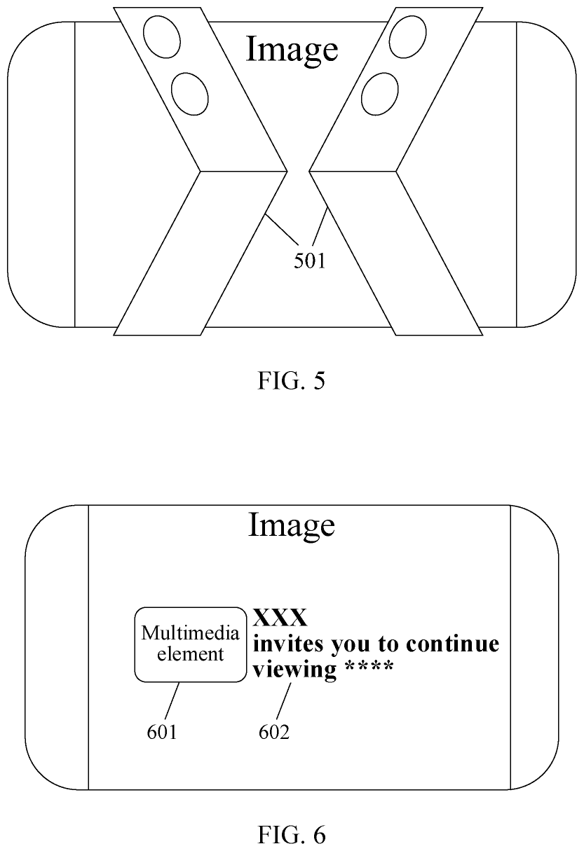

In some embodiments, a partial area in the frame-breaking animation may be displayed in a transparent state, to reduce obstruction of the content displayed on the first playback page. For example, FIG. 5 is a schematic diagram of another playback page according to an embodiment of this application. The terminal is in the landscape orientation and displays a multimedia element 501 on a floating layer of the first playback page.

In some embodiments, through the frame-breaking animation that displays a process of displaying the multimedia element on a layer outside the playback page, a display effect of the multimedia element is improved. The multimedia element indicates the object, and helps the user remember the object. This improves a promotion effect of the object. In addition, the multimedia element can encourage the user to perform interaction to learn more about the object. This further improves a conversion rate of the multimedia element and further improves the promotion effect of the object.

In operation 304, the process of displaying the image of the second multimedia resource on the playback page after the first multimedia resource is played in the second screen playback mode for the fifth duration, and displaying the multimedia element of the object on the image serving as the background image is implemented.

305: The terminal pulls back, in response to duration of displaying a first animation reaching sixth duration, the multimedia element into the background image for display.

The sixth duration refers to presentation duration of the frame-breaking animation. That is, after presentation of the frame-breaking animation is completed, the multimedia element is pulled back into the background image for display. In some embodiments, after presentation of the frame-breaking animation of the multimedia element is completed, the multimedia element is pulled back into the background image for display, that is, the multimedia element finally falls into the background image. This improves smoothness of transition of page display, and further improves a display effect of the multimedia element. After presentation of the frame-breaking animation is completed, the second multimedia resource is directly played. Because the image of the second multimedia resource serves as the background image, the second multimedia resource is directly played based on the image. This further improves smoothness of transition of page display.

In some embodiments, the foregoing process in which the terminal pulls back the multimedia element into the background image for display includes the following operations: The terminal displays a viewing invitation in the background image based on the multimedia element, the viewing invitation being the first prompt information. That is, the first prompt information is displayed in the background image. The first prompt information indicates that the object prompts the user to continue viewing the second multimedia resource. That is, the viewing invitation indicates that the object invites the user to continue viewing the second multimedia resource. In the embodiments, the viewing invitation is displayed through the multimedia element, and the multimedia element indicates the object. This can further deepen impression of the object by the user, enhance the promotion effect of the object, create a sense of opening ceremony, and improve the user experience.

In some embodiments, the viewing invitation (namely, the first prompt information) includes the multimedia element and a text. The copy indicates that the object invites the user to continue viewing the second multimedia resource. For example, FIG. 6 is a schematic diagram of another playback page according to an embodiment of this application. The image and the viewing invitation of the second multimedia resource are displayed on the playback page. The viewing invitation includes a multimedia element 601 and a text 602. The copy 602 is “XXX invites you to continue viewing ****”.

In some embodiments, when displaying the viewing invitation, the terminal plays audio. The audio is configured for representing that the object prompts the user to continue viewing the second multimedia resource. That is, the audio is configured for representing that the object invites the user to continue viewing the second multimedia resource. In this embodiment, the audio indicating that the object invites the user to continue viewing is played while displaying the viewing invitation, and the user can hear content corresponding to the audio. Accordingly, the user is invited to continue viewing in both visual and auditory manners. This can further improve impression of the object by the user, and further improve the promotion effect of the object.

306: The terminal determines, in response to third playback duration reaching fourth duration, that a resource switching condition is satisfied, and plays a second multimedia resource in a second screen playback mode in response to the resource switching condition being satisfied.

The third duration is greater than the fifth duration. That is, before the second multimedia resource is played, the image and the multimedia element are displayed. Correspondingly, display of the image and the multimedia element is canceled while playing the second multimedia resource.

In some embodiments, a sum of the fifth duration and the sixth duration is less than or equal to the fourth duration. After the multimedia element is pulled back into the background image for display, the duration of displaying the first multimedia resource in the second screen playback mode reaches the second duration, and then the second multimedia resource is played in the second screen playback mode. In some embodiments, after the viewing invitation (the first prompt information) is displayed, the duration of displaying the first multimedia resource in the second screen playback mode reaches the second duration, and then the second multimedia resource is played in the second screen playback mode.

In some embodiments, the image includes at least one of a first image and a second image. The first image is a played image of the second multimedia resource, and the second image is a cover image of the second multimedia resource. The process in which the terminal plays the second multimedia resource in the second screen playback mode includes the following implementations: If the image is the first image, the terminal continues to play the second multimedia resource in the second screen playback mode using the first image as a playback starting point; or if the image is the second image, the terminal jumps from the second image to the first image, and continues to play the second multimedia resource in the second screen playback mode using the first image as a playback starting point.

In this embodiment, the displayed image of the to-be-played second multimedia resource is displayed on the playback page, and then playback of the second multimedia resource is continued using the image as a starting point. This improves smoothness of transition of page display, that is, improves a playback effect of the multimedia resource, and further improves viewing experience of the user. A cover image of the to-be-played second multimedia resource is displayed on the playback page. The cover image typically serves as a more prominent prompt for the second multimedia resource. This facilitates establishing a correlation between the first multimedia resource and the second multimedia resource. A jump from the second image to the first image is performed, and playback of the second multimedia resource is continued using the first image as the starting point. This improves smoothness of transition of page display, that is, improves a playback effect of the multimedia resource, and further improves viewing experience of the user.

In the foregoing embodiments, a description is made by using an example in which the image of the second multimedia resource and the multimedia element of the object are simultaneously displayed. In some embodiments, the terminal displays only the image of the second multimedia resource. After displaying the first multimedia resource in the landscape mode for the fifth duration, the terminal displays the image of the second multimedia resource on the first playback page of the first multimedia resource, that is, does not display the multimedia element of the object. In some other embodiments, the terminal displays only the multimedia element of the object. Correspondingly, after displaying the first multimedia resource in the landscape mode for the fifth duration, the terminal displays the multimedia element of the object. The multimedia element indicates the object. In the foregoing embodiments, a process of displaying the image of the second multimedia resource on the first playback page of the first multimedia resource after the first multimedia resource is played in the second screen playback mode for the fifth duration and a process of displaying the multimedia element of the object after the first multimedia resource is played in the second screen playback mode for the fifth duration are implemented. Accordingly, a promotion effect of the object can be further improved.

In some embodiments, in a case that the terminal displays only the image of the second multimedia resource, the terminal plays the second multimedia resource in the second screen playback mode in response to display duration of the image reaching twelfth duration. The eighth duration may be equal to zero. In a case that the image is not displayed, the second multimedia resource is played immediately. In some embodiments, in a case that the terminal displays only the multimedia element of the object, the terminal plays the second multimedia resource in the second screen playback mode in response to presentation of the multimedia element being completed.

In some embodiments, after playing the second multimedia resource on the playback page, the terminal displays introduction information of the object at a preset position on a second playback page of the second multimedia resource. In this embodiment, the introduction information of the object is displayed on the second playback page of the second multimedia resource to further promote the object. This improves an exposure rate of the object, further improves a promotion effect of the object, and further improves a conversion rate of the object.

In some embodiments, during playback of first multimedia resource in the first screen playback mode, a cancel control is displayed. The cancel control is configured to cancel display of the first multimedia resource. Display of the first multimedia resource is canceled in response to a trigger operation for the cancel control, the first screen playback mode is automatically switched to the second screen playback mode, and the second multimedia resource is played in the second screen playback mode. As such, user experience can be further improved, and convenience of switching the screen playback mode is improved.

In some embodiments, a jump from the second playback page to the detail page of the object may be performed in response to a trigger operation for the introduction information of the object. In this embodiment, a jump to the detail page of the object can be performed by triggering the introduction information of the object. This improves diversity and convenience of interaction.

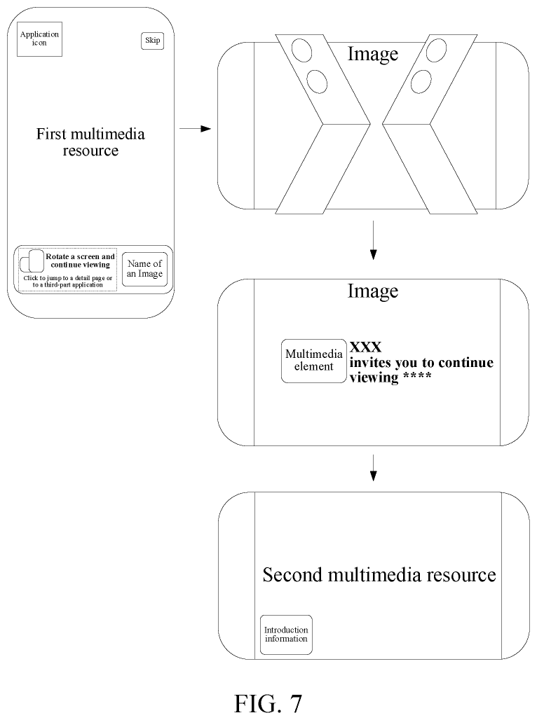

For example, FIG. 7 is an interaction flowchart of playback of a multimedia resource according to an embodiment of this application. First, a terminal plays a first multimedia resource in a portrait mode, and displays guidance information and second prompt information of a second multimedia resource in response to duration of playing the first multimedia resource in the portrait mode reaching first duration. The terminal plays the first multimedia resource in a landscape mode in response to duration of playing the first multimedia resource in the portrait mode reaching the first duration. The terminal displays an image of the second multimedia resource on a playback page and displays a frame-breaking animation of a multimedia element of an object in response to duration of playing the first multimedia resource in the landscape mode reaching fifth duration. The terminal pulls back, in response to duration of displaying a first animation reaching sixth duration, the multimedia element into the playback page to display first prompt information; and plays the second multimedia resource in the landscape mode in response to the duration of playing the first multimedia resource in the landscape mode reaching fourth duration, and displays introduction information of the object on a second playback page of the second multimedia resource.

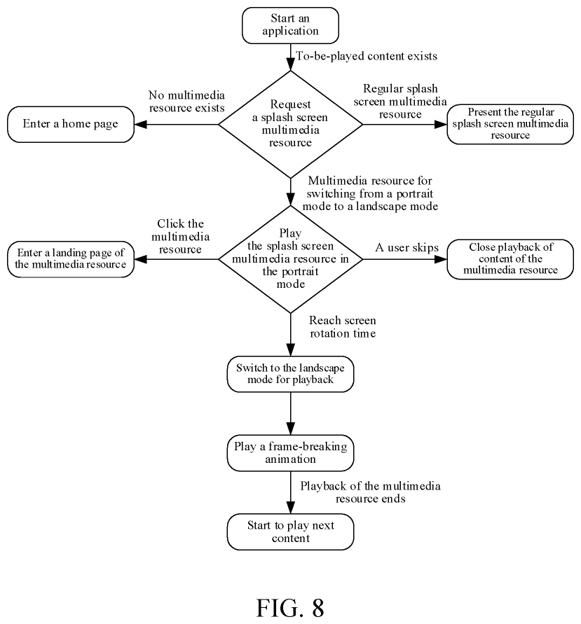

For example, FIG. 8 is a flowchart of multimedia resource playback according to an embodiment of this application. After an application program is started, whether to-be-played content exists in the application program is detected. The to-be-played content refers to a second multimedia resource that has been played but has not yet been fully played in the application program. If the to-be-played content exists, a resource request is transmitted to a server. The resource request is configured for requesting a multimedia resource. In a case that no multimedia resource is obtained, a home page of the application program is directly navigated to. If a regular multimedia resource is obtained, a presentation terminal presents the regular multimedia resource. If a multimedia resource for rotating a screen from a portrait orientation to a landscape orientation (namely, a first multimedia resource) is obtained, the multimedia resource is played in a portrait mode. If a user clicks the multimedia resource, a landing page of the multimedia resource is navigated to. The landing page is a detail page of an object promoted by the multimedia resource. If the user triggers a skip button on a playback page, the multimedia resource is closed and a second multimedia resource that is not fully played is played. If the user does not trigger the skip button, the terminal is switched to the landscape mode after screen rotation time is reached, a frame-breaking animation of the multimedia element is played, and after playback of the frame-breaking animation is completed, a multimedia resource that is not fully played is played, that is, the second multimedia resource is played.

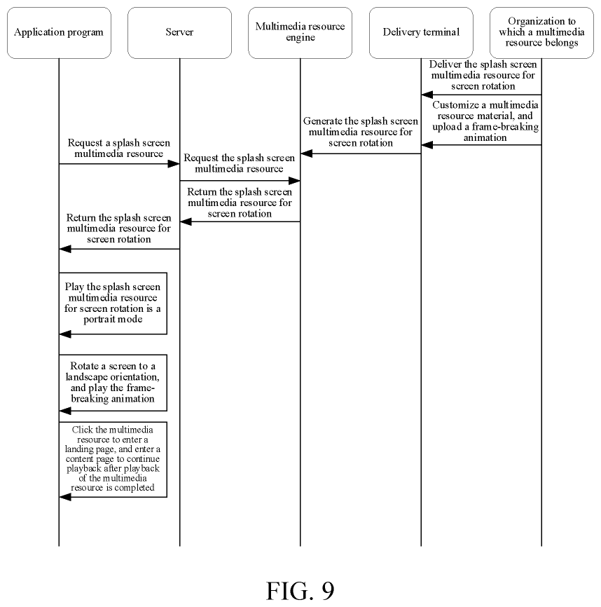

For example, FIG. 9 is a flowchart of another multimedia resource playback according to an embodiment of this application. The entire process is divided into two parts: a multimedia resource creation process and a multimedia resource playback process. In the multimedia resource creation process, an organization to which a multimedia resource belongs selects an object, and then delivers a multimedia resource of the object for screen rotation. A customized material for switching from a portrait mode to a landscape mode, a text, a frame-breaking animation of a multimedia element, and the like are uploaded to a delivery terminal of the multimedia resource. The delivery terminal transmits the content to a multimedia resource engine. The multimedia resource engine generates a multimedia resource for screen rotation and binds the uploaded content. In the multimedia resource playback process, when an application program is started, if a second multimedia resource is being played on the application program, data of the second multimedia resource is carried in a request for the multimedia resource for screen rotation. If a server delivers the multimedia resource for screen rotation, the multimedia resource for screen rotation is played in the portrait mode, and timing starts at the same time. According to the delivered information, the multimedia resource is played in the landscape mode when landscape mode switching time is reached, and the frame-breaking animation is played at the same time. After playback of the splash screen multimedia resource is completed, a second playback page of a second multimedia resource is navigated to for playback. In this process, a user clicks the multimedia resource for screen rotation to enter a landing page, that is, enter a detail page of the object, and if the user clicks a skip button, the second playback page of the second multimedia resource is directly navigated to for playback.

The method according to some embodiments provides a novel presentation form of a multimedia resource. That is, after a splash screen multimedia resource is played for a period of time (corresponding to first duration), a user is guided to switch a terminal from the portrait mode to a landscape mode, and playback of the multimedia resource is continued in the landscape mode. This provides an innovative and highly attractive multimedia resource presentation manner for an organization to which the multimedia resource belongs. According to the method, after the user views a multimedia resource played in the portrait mode for a period of time (corresponding to the first duration), a system immediately triggers a corresponding landscape playback effect in real time, to provide a unique and visually impactful multimedia resource viewing experience for the user. The presentation form of the multimedia resource can closely correlate content of the multimedia resource with a viewing orientation of the user, to increase appeal and interactivity of the multimedia resource in viewing experience of the user. The organization to which the multimedia resource belongs may select a multimedia resource related to a brand or an item characteristic of the organization, to make information conveyed by the multimedia resource precise and targeted. However, to not disturb user experience, presentation of the multimedia resource played in the landscape mode may be set to be closable or to disappear after set duration, to ensure smooth user experience. The presentation form of the multimedia resource provided in the method is applicable to various platforms and devices, such as a mobile phone, a computer, and a tablet, that is, demonstrates broad application potential. The method provides the presentation form that tactfully correlates the multimedia resource and the viewing orientation of the user. This achieves an appealing and visually impactful presentation of the multimedia resource, and enhances an emotional connection between the multimedia resource and the user.

In the method according to some embodiments, first, a visually impactful presentation form of a multimedia resource is achieved. After the multimedia resource is played for several seconds, a user is guided to rotate a screen from a portrait orientation to a landscape orientation, and playback of the multimedia resource is continued in a landscape mode. This closely correlates the presentation of the multimedia resource with a current viewing orientation of the user, enhances a visual impact and appeal of the multimedia resource, and increases attention attractiveness and conversion potential of the multimedia resource. Second, viewing experience of the user is not disturbed. The multimedia resource for switching from the portrait mode to the landscape mode is triggered in a natural viewing process of the user, and browsing experience of the user is not interrupted. This provides a smooth and non-intrusive viewing experience for the user. Moreover, this increases fun and interactivity of the multimedia resource. The multimedia resource for switching from the portrait mode to the landscape mode provides the user with a novel and interesting presentation form of the multimedia resource, and enhances the interactivity of the multimedia resource and user engagement. Finally, memorability of the multimedia resource is enhanced. Because the multimedia resource is closely correlated with the viewing orientation of the user, the user can readily remember content of the multimedia resource. This improves a long-term effect of the multimedia resource. In conclusion, by using the method, problems of an insufficient visual impact of a multimedia resource, misalignment with a viewing orientation of a user, disruption of user experience, and low conversion rate of the multimedia resource may be effectively addressed, to provide a win-win multimedia resource presentation form for both the organization to which the multimedia resource belongs and the user.

The method according to some embodiments can further achieve the following effects. First, viewing experience of a user is enhanced. A user is guided to switch a terminal from a portrait mode to a landscape mode after a multimedia resource is played for several seconds, and playback of the multimedia resource is continued in the landscape mode. This provides the user with a novel viewing experience. When the user views the multimedia resource, a triggered portrait-to-landscape effect may arouse curiosity of the user, which leads to engagement and participation of the user. Second, an innovative presentation form of the multimedia resource is provided. Different from a conventional presentation of a video or a focus image, a splash screen multimedia resource for switching from the portrait mode to the landscape mode provides a novel and attractive presentation form for an organization to which the multimedia resource belongs. This prevents the presentation from being too ordinary to attract the user. Third, memorability of the multimedia resource is enhanced. The splash screen multimedia resource for switching from the portrait mode to the landscape mode is closely correlated with a viewing orientation of the user, and the user may involuntarily remember the related multimedia resource in a switching process. This increases impression of the multimedia resource. Fourth, an audience range of the multimedia resource is expanded. Because the multimedia resource for switching from the portrait mode to the landscape mode is closely correlated with the viewing orientation of the user, this novel presentation form of the multimedia resource may attract different user groups, to expand the audience range of the multimedia resource. Fifth, integration between the multimedia resource and content whose playback is interrupted. In the method, content of the multimedia resource is seamlessly correlated with the viewing orientation of the user. This enhances relevance and appeal of the multimedia resource, and improves a conversion rate. Sixth, curiosity of the user is aroused. A trigger manner of the multimedia resource for switching from the portrait mode to the landscape mode may arouse a desire for exploration of the user, and drive the user to actively view more multimedia resources. This increases a quantity of interactions between the user and a platform. Seventh, more marketing approaches are provided. The organization to which the multimedia resource belongs may design clever portrait-to-landscape effects according to different multimedia elements, to develop diversified and targeted marketing approaches for a product or service of the organization. In conclusion, by using the method, an efficient and innovative presentation form of the multimedia resource is provided for the organization to which the multimedia resource belongs, and rich and interesting viewing experience is provided for the user.

In the foregoing embodiments, the process of playing the multimedia resource is described by using an example of switching from the portrait mode to the landscape mode. In some other embodiments, playing the multimedia resource further includes an implementation of switching from the landscape mode to the portrait mode. A process of the implementation and the process of the implementation of switching from the portrait mode to the landscape mode in the foregoing embodiments belong to the same idea, and details are not described herein again.

In some embodiments, whether a terminal plays a multimedia resource in a portrait-to-landscape manner or plays a multimedia resource in a landscape-to-portrait manner is related to a current handheld orientation of the terminal. Correspondingly, the foregoing process in which the terminal plays the first multimedia resource in the first screen playback mode includes the following implementations: playing the first multimedia resource in the landscape mode in a case that the current handheld orientation of the electronic device is a landscape orientation; or playing the first multimedia resource in the portrait mode in a case that the current handheld orientation of the electronic device is a portrait orientation.

An example in which the electronic device is a terminal is used. In a case where a current handheld orientation of the terminal is the landscape orientation, the terminal plays the first multimedia resource in the landscape mode. In a case where the current handheld orientation of the terminal is the portrait orientation, the terminal plays the first multimedia resource in the portrait mode. As such, the screen playback mode of the first multimedia resource may be determined based on the current handheld orientation of the terminal. Accordingly, the screen playback mode of the first multimedia resource matches a current viewing orientation of the user, to facilitate viewing by the user. This improves viewing experience of the user.

In some embodiments, before the terminal plays the first multimedia resource, the current handheld orientation of the terminal is detected, and the screen playback mode of the first multimedia resource is determined based on the current handheld orientation of the terminal. The screen playback mode matches the current handheld orientation of the terminal. That is, if the current handheld orientation of the terminal is the landscape orientation, the screen playback mode is the landscape mode; or if the current handheld orientation of the terminal is the portrait orientation, the screen playback mode is the portrait mode.

For example, a description is made by using an example in which playback of the first multimedia resource is interleaved during playback of the second multimedia resource. After the second multimedia resource is played for the third duration, that is, a playback time point of the first multimedia resource is reached, the current handheld orientation of the terminal is detected. In a case that a detection result indicates that the current handheld orientation of the terminal is the landscape orientation, the terminal plays the first multimedia resource in the landscape mode; or in a case that a detection result indicates that the current handheld orientation of the terminal is the portrait orientation, the terminal plays the first multimedia resource in the portrait mode.

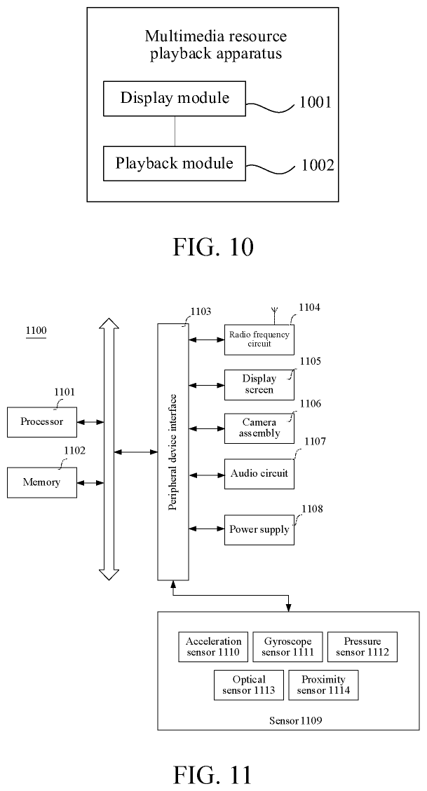

FIG. 10 is a block diagram of a multimedia resource playback apparatus according to an embodiment of this application. Refer to FIG. 10. The apparatus includes:
a display module 1001, configured to display, during playback of a first multimedia resource in a first screen playback mode, guidance information in response to a playback mode switching condition being satisfied, the guidance information being configured for guiding switching from the first screen playback mode to a second screen playback mode; and
a playback module 1002, configured to play the first multimedia resource in the second screen playback mode in response to a switching instruction triggered based on the guidance information,
the playback module 1002 being configured to play a second multimedia resource in the second screen playback mode in response to a resource switching condition being satisfied, the second multimedia resource being adapted to the second screen playback mode.

In some embodiments, the first screen playback mode is a landscape mode or a portrait mode, and the playback module 1002 is further configured to:
play the first multimedia resource in the landscape mode in a case that a current handheld orientation of an electronic device is a landscape orientation; or
play the first multimedia resource in the portrait mode in a case that a current handheld orientation of an electronic device is a portrait orientation.

In some embodiments, the display module 1001 is further configured to:
display the guidance information in the form of a text or in the form of an icon.

In some embodiments, the display module 1001 is further configured to:
display a dynamic icon, the dynamic icon being configured to demonstrate a process of rotating a screen of the electronic device.

In some embodiments, before the guidance information is displayed in response to the playback mode switching condition being satisfied, the playback module 1002 is further configured to perform at least one of the following:
determine, in response to first playback duration reaching first duration, that the playback mode switching condition is satisfied, the first playback duration being duration of playing the first multimedia resource in the first screen playback mode; and
determine, in response to second playback duration reaching second duration, that the playback mode switching condition is satisfied, the second playback duration being configured for playing the second multimedia resource in a case that the second playback duration is equal to 0.

In some embodiments, before the guidance information is displayed in response to the playback mode switching condition being satisfied, the playback module 1002 is further configured to perform at least one of the following:
play the first multimedia resource in the first screen playback mode in response to duration of playing the second multimedia resource reaching third duration;
play the first multimedia resource in the first screen playback mode in response to a page of an application program being displayed and the second multimedia resource being played when display of the page is last canceled; and
play the first multimedia resource in the first screen playback mode in response to a playback instruction for the second multimedia resource.

In some embodiments, the playback module 1002 is further configured to determine, in response to third playback duration reaching fourth duration, that the resource switching condition is satisfied, the third playback duration being duration of playing the first multimedia resource in the second screen playback mode; or
determine, in response to playback of the first multimedia resource being completed, that the resource switching condition is satisfied.

In some embodiments, the display module 1001 is further configured to perform any one of the following:
display an image of the second multimedia resource on a first playback page of the first multimedia resource in response to the third playback duration reaching fifth duration, the fifth duration being less than the fourth duration;
display, in a case that the first multimedia resource is configured for recommending an object, a multimedia element of the recommended object in response to the third playback duration reaching the fifth duration; and
display the image of the second multimedia resource on the first playback page in response to the third playback duration reaching the fifth duration, and display the multimedia element of the object in the image serving as a background image.

In some embodiments, the display module 1001 is further configured to:
display a first animation of the multimedia element, the multimedia element being displayed in a manner of being moved out of the first playback page in the first animation.

In some embodiments, the display module 1001 is further configured to:
pull back, in response to duration of displaying the first animation reaching sixth duration, the multimedia element into the background image for display.

In some embodiments, the display module 1001 is further configured to:
display first prompt information in the background image based on the multimedia element, the first prompt information indicating that the object prompts to continue viewing the second multimedia resource.

In some embodiments, the playback module 1002 is further configured to:
play audio during display of the first prompt information, the audio being configured for representing that the object prompts to continue viewing the second multimedia resource.

In some embodiments, the image includes at least one of a first image and a second image. The first image is a played image of the second multimedia resource, and the second image is a cover image of the second multimedia resource. The playback module 1002 is configured to:
play, if the image is the first image, the second multimedia resource in the second screen playback mode using the first image as a playback starting point; or
jump from the second image to the first image if the image is the second image, and play the second multimedia resource in the second screen playback mode using the first image as a playback starting point.

In some embodiments, in a case where the first multimedia resource is configured for recommending an object, after the second multimedia resource is played in the second screen playback mode, the display module 1001 is further configured to display introduction information of the object at a preset position on a second playback page of the second multimedia resource.

In some embodiments, the apparatus further includes:
a jumping module, configured to jump to a detail page of the object in response to a trigger operation for the introduction information of the object.

In some embodiments, the display module 1001 is further configured to:
display second prompt information of the second multimedia resource in response to the playback mode switching condition being satisfied, the second prompt information being configured for prompting the to-be-played second multimedia resource.

In some embodiments, the playback module 1002 is further configured to:
jump to the second playback page of the second multimedia resource in response to a trigger operation for the second prompt information, and play the second multimedia resource.

In some embodiments, the playback module 1002 is further configured to:
display a cancel control during playback of the first multimedia resource in the first screen playback mode, the cancel control being configured to cancel display of the first multimedia resource; and
cancel display of the first multimedia resource in response to a trigger operation for the cancel control, automatically switch the first screen playback mode to the second screen playback mode, and play the second multimedia resource in the second screen playback mode.

Some embodiments provide the multimedia resource playback apparatus. The apparatus displays the guidance information during playback of the first multimedia resource in the first screen playback mode, to guide a user to rotate a screen to view the multimedia resource played in the second screen playback mode. In addition, after playing the first multimedia resource in the second screen playback mode for a period of time, the terminal plays the second multimedia resource in the second screen playback mode. The apparatus switches the first screen playback mode of the multimedia resource to the second screen playback mode. This improves diversity of presentation of the multimedia resource. Furthermore, the guidance information is displayed to guide the user to rotate the screen. This improves diversity of interaction modes. In addition, after the apparatus guides the user to rotate the screen, and after playback of the first multimedia resource in the second screen playback mode is completed, the second multimedia resource is then directly played in the second screen playback mode. Accordingly, because the user is guided to rotate the screen before the second multimedia resource is played, the user may directly view the second multimedia resource played in the second screen playback mode without performing any operation. This closely correlates the presentation of the multimedia resource with a viewing orientation of the user, enhances a visual impact and appeal of the multimedia resource, and further improves viewing experience of the multimedia resource by the user. In addition, playing the multimedia resource in such a novel and attractive presentation form can attract attention of the user, increase a conversion rate of the first multimedia resource, and further improve a promotion effect of the object promoted by the first multimedia resource.

When playing the multimedia resource, the multimedia resource playback apparatus according to the foregoing embodiments is described only using the division of the foregoing functional modules as an example. In practice, the foregoing functions may be allocated to and completed by different functional modules as required. In other words, an internal structure of the apparatus is divided into different functional modules to complete all or some of the functions described above. In addition, the multimedia resource playback apparatus according to the foregoing embodiments and the multimedia resource playback method according to the foregoing embodiments belong to the same idea. For a specific implementation process of the apparatus embodiments, refer to the method embodiments. Details are not described herein again.

In some embodiments, the electronic device may be a terminal or a server. When the electronic device is a terminal, the technical solutions provided in some embodiments are implemented by the terminal. When the electronic device is a server, the technical solutions provided in some embodiments are implemented by the server. Alternatively, the technical solutions provided in this application are implemented through interaction between the terminal and the server. This is not limited in some embodiments.

FIG. 11 is a block diagram of a terminal according to an embodiment of this application. That is, FIG. 11 provides a structural block diagram of a terminal according to an embodiment of this application.

Typically, a terminal 1100 includes: a processor 1101 and a memory 1102.

The processor 1101 may include one or more processing cores, such as a 4-core processor or an 8-core processor. The processor 1101 may be implemented by using at least one hardware form of a digital signal processor (DSP), a field-programmable gate array (FPGA), and a programmable logic array (PLA). The processor 1101 may alternatively include a main processor and a coprocessor. The main processor is a processor configured to process data in an awake state, and is also referred to as a central processing unit (CPU). The co-processor is a low-power processor configured to process data in a standby state. In some embodiments, the processor 1101 may have a graphics processing unit (GPU) integrated therein. The GPU is configured to render and draw content that needs to be displayed on a display screen. In some embodiments, the processor 1101 may further include an AI processor. The AI processor is configured to process computing operations related to machine learning.

The memory 1102 may include one or more computer-readable storage media. The computer-readable storage medium may be non-transitory. The memory 1102 may further include a high-speed random-access memory and a non-volatile memory, such as one or more disk storage devices and flash storage devices. In some embodiments, the non-transitory computer-readable storage medium in the memory 1102 is configured to store at least one piece of program code. The at least one piece of program code is executed by the processor 1101 to implement the multimedia resource playback method according to the method embodiments of this application.

In some embodiments, the terminal device 1100 may further include: a peripheral device interface 1103 and at least one peripheral device. The processor 1101, the memory 1102, and the peripheral device interface 1103 may be connected via a bus or a signal cable. The peripheral device may be connected to the peripheral device interface 1103 via a bus, a signal cable, or a circuit board. Specifically, the peripheral device includes at least one of a radio frequency (RF) circuit 1104, a display screen 1105, a camera assembly 1106, an audio circuit 1107, and a power supply 1108.

The peripheral device interface 1103 may be configured to connect at least one input/output (I/O)-related peripheral device to the processor 1101 and the memory 1102. In some embodiments, the processor 1101, the memory 1102, and the peripheral device interface 1103 are integrated on a same chip or circuit board. In some other embodiments, any one or two of the processor 1101, the memory 1102, and the peripheral device interface 1103 may be implemented on an independent chip or circuit board. This is not limited in this embodiment.

The RF circuit 1104 is configured to receive and transmit an RF signal, which is also referred to as an electromagnetic signal. The RF circuit 1104 communicates with a communication network and another communication device through the electromagnetic signal. The RF circuit 1104 converts an electric signal into an electromagnetic signal for transmission, or converts a received electromagnetic signal into an electric signal. In some embodiments, the RF circuit 1104 includes: an antenna system, an RF transceiver, one or more amplifiers, a tuner, an oscillator, a DSP, a codec chip set, a subscriber identity module card, and the like. The RF circuit 1104 may communicate with another terminal by using at least one wireless communication protocol. The wireless communication protocol includes, but is not limited to, the World Wide Web, a metropolitan area network, an intranet, various generations of mobile communication networks (2G, 3G, 4G, and 5G), a wireless local area network, and/or a Wireless Fidelity (Wi-Fi) network. In some embodiments, the RF circuit 1104 may further include a near field communication (NFC)-related circuit. This is not limited in this application.

The display screen 1105 is configured to display a user interface (UI). The UI may include a graphic, text, an icon, a video, and any combination thereof. When the display screen 1105 is a touch display screen, the display screen 1105 further has a capability to capture a touch signal on or above a surface of the display screen 1105. The touch signal may be inputted to the processor 1101 as a control signal for processing. In this case, the display screen 1105 may be further configured to provide a virtual button and/or a virtual keyboard, which are/is also referred to as a soft button and/or a soft keyboard. In some embodiments, one display screen 1105 may be provided and disposed on a front panel of the terminal 1100. In some other embodiments, at least two display screens 1105 are provided and respectively disposed on different surfaces of the terminal 1100 or in a folded design. In some other embodiments, the display screen 1105 may be a flexible display screen and is disposed on a curved surface or a folded surface of the terminal 1100. The display screen 1105 may be even configured as a non-rectangular irregular shape, namely, a special-shaped screen. The display screen 1105 may be made of a material such as a liquid crystal display (LCD) or an organic light-emitting diode (OLED).

The camera assembly 1106 is configured to collect an image or a video. In some embodiments, the camera assembly 1106 includes a front camera and a rear camera. Typically, the front camera is disposed on the front panel of the terminal, and the rear camera is disposed on the back of the terminal. In some embodiments, at least two rear cameras are provided, which are respectively any of a main camera, a depth-of-field camera, a wide-angle camera, and a telephoto camera, to achieve a background blurring function through a combination of the main camera and the depth-of-field camera, panoramic photographing and virtual reality (VR) photographing functions through a combination of the main camera and the wide-angle camera, or other fused photographing functions. In some embodiments, the camera assembly 1106 may further include a flash. The flash may be a single color temperature flash or a double color temperature flash. The double color temperature flash is a combination of a warm flash and a cold flash, and may be configured to perform light ray compensation at different color temperatures.

The audio circuit 1107 may include a microphone and a speaker. The microphone is configured to collect sound waves of a user and an environment, convert the sound waves into an electrical signal, and input the electrical signal to the processor 1101 for processing, or input the electrical signal to the RF circuit 1104 for voice communication. For the purpose of stereo collection or noise reduction, a plurality of microphones may be provided and respectively disposed at different parts of the terminal 1100. The microphone may be further an array microphone or an omnidirectional collection microphone. The speaker is configured to convert an electrical signal from the processor 1101 or the RF circuit 1104 into sound waves. The speaker may be a conventional thin-film speaker or a piezoelectric ceramic speaker. When the speaker is a piezoelectric ceramic speaker, the speaker can not only convert the electrical signal into sound waves audible to a human being, but also convert the electrical signal into sound waves inaudible to the human being for ranging and other purposes. In some embodiments, the audio circuit 1107 may further include a headphone jack.

The power supply 1108 is configured to supply power to components in the terminal 1100. The power supply 1108 may be an alternating current battery, a direct current battery, a disposable battery, or a rechargeable battery. When the power supply 1108 includes a rechargeable battery, the rechargeable battery may be a wired rechargeable battery or a wireless rechargeable battery. The wired rechargeable battery refers to a battery charged via a wired connection, and the wireless rechargeable battery refers to a battery charged via a wireless coil. The rechargeable battery may further support a fast recharging technology.

In some embodiments, the terminal 1100 further includes one or more sensors 1109. The one or more sensors 1109 include, but are not limited to, an acceleration sensor 1110, a gyroscope sensor 1111, a pressure sensor 1112, an optical sensor 1113, and a proximity sensor 1114.

The acceleration sensor 1110 may detect a magnitude of acceleration on three coordinate axes of a coordinate system established based on the terminal 1100. For example, the acceleration sensor 1110 may be configured to detect components of gravity acceleration on the three coordinate axes. The processor 1101 may control, based on a gravity acceleration signal collected by the acceleration sensor 1110, the display screen 1105 to display the UI in a landscape view or a portrait view. The acceleration sensor 1110 may be further configured to collect motion data of a game or a user.

The gyroscope sensor 1111 may detect a body direction and a rotation angle of the terminal 1100. The gyroscope sensor 1111 may cooperate with the acceleration sensor 1110 to collect a three-dimensional (3D) motion performed by the user for the terminal 1100. The processor 1101 may implement the following functions according to the data collected by the gyroscope sensor 1111: motion sensing (such as changing the UI according to a tilt operation of the user), image stabilization at photographing, game control, and inertial navigation.

The pressure sensor 1112 may be disposed at a side frame of the terminal 1100 and/or on a lower layer of the display screen 1105. When the pressure sensor 1112 is disposed at the side frame of the terminal 1100, a holding signal of the user for the terminal 1100 may be detected. The processor 1101 performs left/right hand recognition or a quick operation based on the holding signal collected by the pressure sensor 1112. When the pressure sensor 1112 is arranged on the lower layer of the display screen 1105, the processor 1101 controls an operable control on the UI based on a pressure operation of the user for the display screen 1105. The operable control includes at least one of a button control, a scroll bar control, an icon control, and a menu control.

The optical sensor 1113 is configured to collect ambient light intensity. In an embodiment, the processor 1101 may control display brightness of the display screen 1105 based on the ambient light intensity collected by the optical sensor 1113. Specifically, when the ambient light intensity is high, display brightness of the display screen 1105 is increased. When the ambient light intensity is low, display brightness of the display screen 1105 is decreased. In another embodiment, the processor 1101 may further dynamically adjust a camera parameter of the camera assembly 1106 based on the ambient light intensity collected by the optical sensor 1113.

The proximity sensor 1114, also referred to as a distance sensor, is typically disposed on the front panel of the terminal 1100. The proximity sensor 1114 is configured to collect a distance between a user and a front surface of the terminal 1100. In an embodiment, when the proximity sensor 1114 detects that the distance between the user and the front face of the terminal 1100 gradually decreases, the processor 1101 controls the display screen 1105 to switch from a lit state to an unlit state. When the proximity sensor 1114 detects that the distance between the user and the front face of the terminal 1100 gradually increases, the processor 1101 controls the display screen 1105 to switch from the unlit state to the lit state.

A person skilled in the art may understand that the structure shown in FIG. 11 does not constitute a limitation on the terminal 1100. The terminal may include more or fewer components than those shown in the figure, or some components are combined, or different component arrangements are adopted.

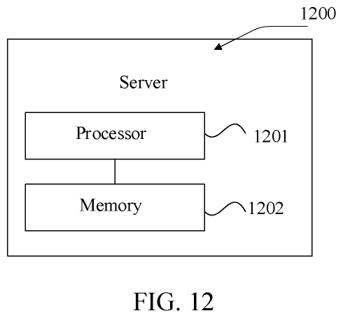

FIG. 12 is a block diagram of a server according to an embodiment of this application, namely, a schematic structural diagram of a server according to an embodiment of this application. A server 1200 may vary greatly due to different configurations or performance, and may include one or more CPUs 1201 and one or more memories 1202. The memory 1202 is configured to store executable program code, and the processor 1201 is configured to execute the foregoing executable program code, to implement the multimedia resource playback method according to the foregoing method embodiments. In some embodiments, the server may further have components such as a wired or wireless network interface, a keyboard, and an I/O interface, to perform input and output. The server may further include another component configured to implement a device function. Details are not described herein again.

Some embodiments further provide a computer-readable storage medium. The computer-readable storage medium has at least one program stored therein, and the at least one program is loaded and executed by a processor to implement the multimedia resource playback method according to any one of the foregoing implementations.

Some embodiments further provide a computer program product, including at least one program. The at least one program is stored in a computer-readable storage medium, and a processor of an electronic device reads the at least one program from the computer-readable storage medium, and executes the at least one program, to cause the electronic device to perform the multimedia resource playback method according to any one of the foregoing implementations.

In some embodiments, the computer program involved in some embodiments may be deployed in one computer device for execution, or deployed in a plurality of computer devices at one location for execution, or deployed in a plurality of computer devices that are distributed at a plurality of locations and that are connected via a communication network for execution. The plurality of computer devices that are distributed at the plurality of locations and that are connected via the communication network may form a blockchain system.

All of the foregoing technical solutions may be combined in any manner to form different embodiments of this application. Details are not described herein again. The above are merely exemplary embodiments of this application, but are not intended to limit this application. Any modification, equivalent replacement, or improvement made within the spirit and principle of this application fall within the scope of protection of this application.

What is claimed is:

1. A multimedia resource playback method, performed by an electronic device and comprising:
displaying guidance information in response to a playback mode switching condition being satisfied during playback of a first multimedia resource in a first screen playback mode, the guidance information being configured to guide switching from the first screen playback mode to a second screen playback mode;
playing the first multimedia resource in the second screen playback mode in response to a switching instruction based on the guidance information; and
playing a second multimedia resource in the second screen playback mode in response to a resource switching condition being satisfied, the second multimedia resource being adapted to the second screen playback mode.

2. The method according to claim 1, wherein the first screen playback mode is a landscape mode or a portrait mode, and before the displaying guidance information in response to a playback mode switching condition being satisfied, the method further comprises:
playing the first multimedia resource in the landscape mode in a case that a current handheld orientation of the electronic device is a landscape orientation; or
playing the first multimedia resource in the portrait mode in a case that a current handheld orientation of the electronic device is a portrait orientation.

3. The method according to claim 1, wherein the displaying guidance information comprises:
displaying the guidance information in the form of a text or in the form of an icon.

4. The method according to claim 3, wherein the displaying the guidance information in the form of an icon comprises:
displaying a dynamic icon, the dynamic icon being configured to demonstrate a process of rotating a screen of the electronic device.

5. The method according to claim 1, before the displaying guidance information in response to a playback mode switching condition being satisfied, further comprising at least one of the following:
determining that the playback mode switching condition is satisfied in response to first playback duration reaching a first duration, the first playback duration being duration of playing the first multimedia resource in the first screen playback mode; and
determining that the playback mode switching condition is satisfied in response to second playback duration reaching a second duration, the second playback duration being configured for playing the second multimedia resource in a case that the second playback duration is equal to 0.

6. The method according to claim 1, before the displaying guidance information in response to a playback mode switching condition being satisfied, further comprising any one of the following:
playing the first multimedia resource in the first screen playback mode in response to a duration of playing the second multimedia resource reaching a third duration;
playing the first multimedia resource in the first screen playback mode in response to a page of an application program being displayed and the second multimedia resource being played when display of the page is last canceled; and
playing the first multimedia resource in the first screen playback mode in response to a playback instruction for the second multimedia resource.

7. The method according to claim 1, before the playing a second multimedia resource in the second screen playback mode in response to a resource switching condition being satisfied, further comprising at least one of the following:
determining, in response to third playback duration reaching fourth duration, that the resource switching condition is satisfied, the third playback duration being duration of playing the first multimedia resource in the second screen playback mode; and
determining, in response to playback of the first multimedia resource being completed, that the resource switching condition is satisfied.

8. The method according to claim 1, further comprising at least one of the following:
displaying an image of the second multimedia resource on a first playback page of the first multimedia resource in response to the third playback duration reaching fifth duration, the fifth duration being less than the fourth duration, and the third playback duration being the duration of playing the first multimedia resource in the second screen playback mode;
displaying, in a case that the first multimedia resource is configured for recommending an object, a multimedia element of the object in response to the third playback duration reaching the fifth duration; and
displaying the image of the second multimedia resource on the first playback page in response to the third playback duration reaching the fifth duration, and displaying the multimedia element of the object in the image serving as a background image.

9. The method according to claim 8, wherein the displaying a multimedia element of the recommended object comprises:
displaying a first animation of the multimedia element, the multimedia element being displayed in a manner of being moved out of the first playback page in the first animation.

10. The method according to claim 9, further comprising:
pulling back the multimedia element into the background image for display in response to duration of displaying the first animation reaching sixth duration.

11. The method according to claim 10, wherein the pulling back the multimedia element into the background image for display comprises:
displaying first prompt information in the background image based on the multimedia element, the first prompt information indicating the object and prompting a user to continue viewing the second multimedia resource.

12. The method according to claim 11, further comprising:
playing audio during display of the first prompt information, the audio being configured for representing that the object prompts to continue viewing the second multimedia resource.

13. The method according to claim 8, wherein the image comprises at least one of a first image and a second image, the first image is a played image of the second multimedia resource, and the second image is a cover image of the second multimedia resource; and the playing a second multimedia resource in the second screen playback mode comprises:
playing the second multimedia resource in the second screen playback mode using the first image as a playback starting point, if the image is the first image; or
jumping from the second image to the first image, if the image is the second image, and playing the second multimedia resource in the second screen playback mode using the first image as a playback starting point.

14. The method according to claim 1, wherein the first multimedia resource is configured for recommending the object, and after the playing a second multimedia resource in the second screen playback mode, the method further comprises:
displaying introduction information of the object at a preset position on a second playback page of the second multimedia resource.

15. The method according to claim 14, further comprising:
jumping to a detail page of the object in response to a trigger operation for the introduction information of the object.

16. The method according to claim 1, further comprising:
displaying second prompt information of the second multimedia resource in response to the playback mode switching condition being satisfied, the second prompt information being configured for prompting the to-be-played second multimedia resource.

17. The method according to claim 16, further comprising:
jumping to the second playback page of the second multimedia resource in response to a trigger operation for the second prompt information, and playing the second multimedia resource.

18. The method according to claim 1, further comprising:
displaying a cancel control during playback of the first multimedia resource in the first screen playback mode, the cancel control being configured to cancel display of the first multimedia resource; and
canceling display of the first multimedia resource in response to a trigger operation for the cancel control, automatically switching the first screen playback mode to the second screen playback mode, and playing the second multimedia resource in the second screen playback mode.

19. An electronic device, comprising a processor and a memory, the memory being configured to store at least one program, and the at least one program being loaded and executed by the processor to implement a multimedia resource playback method, comprising:
displaying guidance information in response to a playback mode switching condition being satisfied during playback of a first multimedia resource in a first screen playback mode, the guidance information guiding switching from the first screen playback mode to a second screen playback mode;
playing the first multimedia resource in the second screen playback mode in response to a switching instruction based on the guidance information; and
playing a second multimedia resource in the second screen playback mode in response to a resource switching condition being satisfied, the second multimedia resource being adapted to the second screen playback mode.

20. A non-transitory computer-readable storage medium, configured to store at least one program, the at least one program being configured for implementing a multimedia resource playback method, comprising:
displaying guidance information in response to a playback mode switching condition being satisfied during playback of a first multimedia resource in a first screen playback mode, the guidance information guiding switching from the first screen playback mode to a second screen playback mode;
playing the first multimedia resource in the second screen playback mode in response to a switching instruction based on the guidance information; and
playing a second multimedia resource in the second screen playback mode in response to a resource switching condition being satisfied, the second multimedia resource being adapted to the second screen playback mode.
